(19) United States
(12) Patent Application Publication
(10) Pub. No.: US 2009/0296517 A1
(43) Pub. Date: Dec. 3, 2009

(54) Auger for vertical mixer

(75) Inventor: Jakob Tamminga, Orton (CA)

Correspondence Address: DILWORTH & BARRESE, LLP, 1000 WOODBURY ROAD, SUITE 405, WOODBURY, NY, 11797, US

(73) Assignee: Jay-Lor International Inc., Orton (CA)

(21) Appl. No.: 12/387,019

(22) Filed: Apr. 27, 2009

(30) Foreign Application Priority Data
Apr. 29, 2008 (CA) 2627001
Apr. 29, 2008 (CA) 2653082
Apr. 29, 2008 (CA) 2653746
Oct. 28, 2008 (CA) 2641928
Feb. 27, 2009 (CA) 2656353

(51) Int. Cl. B01F 7/32

(52) U.S. Cl. 366/314

(57) ABSTRACT

A vertical mixer having an improved auger for mixing bulk material is disclosed herein. The vertical mixer comprises a mixing chamber for receiving the bulk material. The mixing chamber being defined by a floor and a peripheral wall and includes a door for allowing exit of mixed bulk material. The vertical auger in the mixing chamber has an auger post and flighting including a bottom flight. The bottom flight has a front leading edge and an outside edge defining an outside footprint of the bottom flight. A slide plate is connected to the bottom flight for guiding bulk material at least inwards towards the auger post. The slide plate comprises a front corner; a bottom edge; and a top edge opposite the bottom edge. The bottom edge has a portion closer to the auger post than the front corner, and a portion extending inward on the bottom flight away from the outside edge of the bottom flight. The slide plate extends from the bottom flight at a shallow angle β relative the floor of the mixing chamber.

### FIELD OF INVENTION

The present invention is directed to vertical mixers and more specifically to vertical augers for use with vertical mixers which mix bulk material more effectively.

### BACKGROUND

Feed for livestock typically includes different ingredients which are required to be mixed together before they are provided to the livestock. For example, hay may be mixed with a variety of feed supplements, such as vitamins, to provide a bulk feed material. Various mixers are known which are designed to mix the bulk feed material to a desired extent. Vertical mixers are disclosed, for instance, in U.S. Pat. No. 5,863,122 (Tamminga) and in U.S. Pat. No. 5,462,354 (Neier).

Many prior art feed mixers include a tub having one or more walls and a floor defining a mixing chamber, with a mixing means, typically one or more augers, vertically positioned in a mixing chamber. In conventional use, the components of the bulk material are cut and mixed together by rotation of the auger. After mixing, the mixed bulk material is removed from the tub and dispensed as appropriate.

The amounts of feed material to be mixed are usually relatively large. For example, a load of bulk material in a mixer can weigh as much as 10,000 lbs. or more. Depending on the density of the of bulk material, mixing of the bulk material typically requires a large amount of force be applied to turn the auger. This requires a powerful engine, which results in high consumption of fuel, and greater wear to the mixer and its components. Also, mixing of the bulk materials is typically slow, i.e., 10 minutes or more is usually required depending on the vertical mixer and the amount of material.

Additionally, typical augers are shaped such that bulk material is pushed upwards in a compacting and damaging motion causing several problems. One such problem is that a large amount of material may be thrown from the mixing chamber resulting in a significant amount of waste of material. Another such problem is that the bulk material is packed together and has clumps resulting in poorly mixed feed.

There is therefore a need for an improved auger for a vertical mixer, which addresses or mitigates one or more of the defects of the prior art.

### SUMMARY OF INVENTION

A vertical mixer for mixing bulk material is provided including an auger having an auger post and flighting comprising of at least a bottom flight. In one embodiment the bottom flight of the auger includes a slide plate for guiding bulk material in an outer region of a mixing chamber at least inwards towards the auger post where it is then generally directed upwards thereby causing the bulk material to be cut and mixed. The bottom flight and the slide plate are shaped and connected such that compacting and damaging of the bulk material during mixing is reduced thereby providing a higher quality mixed bulk material. In another embodiment, the flighting includes a second flight above the bottom flight and the second flight has an increasing pitch relative the bottom flight. In another embodiment, the vertical mixer comprises a spacer device including a component extending bellow the bottom flight for contact with a floor of the mixing chamber for providing support to at least a portion of the bottom flight. The spacer device prevents or mitigates flex of the bottom flight when load has been placed thereupon.

In one illustrative embodiment there is provided a vertical mixer for mixing bulk material, the vertical mixer comprising:
a mixing chamber for receiving the bulk material, the mixing chamber being defined by a floor and a peripheral wall, the mixing chamber comprising a door for allowing exit of mixed bulk material;
a vertical auger in the mixing chamber, the vertical auger having an auger post and flighting including a bottom flight, the bottom flight having a front leading edge and an outside edge defining an outside footprint of the bottom flight; and
a slide plate connected to the bottom flight for guiding bulk material at least inwards towards the auger post, the slide plate comprising:
   a front corner;
   a bottom edge; and
   a top edge opposite the bottom edge;
   the bottom edge having a portion closer to the auger post than the front corner; and
      the slide plate extending from the bottom flight at a shallow angle β from the floor of the mixing chamber.

In a further illustrative embodiment of the vertical mixer outlined above, a distance between the front leading edge and the front corner A and a length of the top edge B has a ratio of between about 0:100 and about 30:70.

In a further illustrative embodiment of the vertical mixer outlined above, the slide plate further comprises a portion extending inward on the bottom flight away from the outside edge of the bottom flight.

In a further illustrative embodiment of the vertical mixer outlined above, the portion of the bottom edge closer to the auger post than the front corner and the portion of the bottom edge extending inward on the bottom flight away from the outside edge of the bottom flight overlap.

In a further illustrative embodiment of the vertical mixer outlined above, the top edge of the slide plate extends beyond the outside edge of the bottom flight.

In a further illustrative embodiment of the vertical mixer outlined above, the top edge of the slide pate extends beyond the outside edge of the bottom flight and is substantially proximate a portion of an interior side of the peripheral wall of the mixing chamber.

In a further illustrative embodiment of the vertical mixer outlined above, the bottom flight further comprises a flat section substantially parallel with the floor of the mixing chamber, and a second flight of the auger has an increasing pitch relative the bottom flight.

In a further illustrative embodiment of the vertical mixer outlined above, the bottom flight further comprises an angled section between the leading edge and the flat section such that the leading edge is closer to the floor than the flat section.

In a further illustrative embodiment of the vertical mixer outlined above, the angled section is at least 6 inches in length.

In a further illustrative embodiment of the vertical mixer outlined above, the front corner of the slide plate is connected proximate the front leading edge of the bottom flight.

In a further illustrative embodiment of the vertical mixer outlined above, the front corner of the slide plate is connected proximate the front leading edge of the bottom flight and the slide plate is connected to at least a portion of the flat section.

In a further illustrative embodiment of the vertical mixer outlined above, the front corner of the slide plate is connected proximate the front leading edge of the bottom flight and the slide plate is connected to at least a portion of both of the flat section and the angled section.

In a further illustrative embodiment of the vertical mixer outlined above, the slide plate includes a concave portion.

In a further illustrative embodiment of the vertical mixer outlined above, the shallow angle β is less than 25°.

In a further illustrative embodiment of the vertical mixer outlined above, the shallow angle β is between about 5° and 20°.

In a further illustrative embodiment of the vertical mixer outlined above, the vertical auger further comprises a spear plate extending forward beyond the front leading edge, the spear plate comprising a pointed front corner.

In a further illustrative embodiment of the vertical mixer outlined above, the vertical auger further comprises a spacer device connected to the bottom flight comprising a part thereof for contact with the floor of the mixing chamber.

In a further illustrative embodiment of the vertical mixer outlined above, the spacer device is selected from the group consisting of a bearing surface, a wear surface, and a block.

In another illustrative embodiment there is provided a vertical mixer for mixing bulk material, the vertical mixer comprising:
a mixing chamber for receiving the bulk material, the mixing chamber being defined by a floor and a peripheral wall, the mixing chamber comprising a door for allowing exit of mixed bulk material;
a vertical auger in the mixing chamber, the vertical auger having an auger post and flighting including a bottom flight, the bottom flight comprising:
   a front leading edge;
   an outside edge defining an outside footprint of the bottom flight;
   a flat section substantially parallel with the floor of the mixing chamber; and
   an angled section connecting the front leading edge and the flat section such that the leading edge is closer to the floor than the flat section, the angled section having a length of at least 6 inches.

In a further illustrative embodiment of the vertical mixer outlined above, the auger further includes a slide plate connected to the flat section and the angled section of the bottom flight at a shallow angle β relative the floor of the mixing chamber for guiding bulk material at least inwards towards the auger post, the slide plate comprising:
a front corner;
a bottom edge; and
a top edge opposite the bottom edge;
the bottom edge having a portion closer to the auger post than the front corner.

In a further illustrative embodiment of the vertical mixer outlined above, a distance between the front leading edge of the bottom flight and the front corner A and a length of the top edge B has a ratio of between about 0:100 and about 30:70.

In a further illustrative embodiment of the vertical mixer outlined above, the slide plate further includes a portion extending inward on the bottom flight away from the outside edge of the bottom flight.

In a further illustrative embodiment of the vertical mixer outlined above, the portion of the bottom edge closer to the auger post than the front corner and the portion of the bottom edge extending inward on the bottom flight away from the outside edge of the bottom flight overlap.

In a further illustrative embodiment of the vertical mixer outlined above, the auger further comprises a spear plate extending forward beyond the front leading edge, the spear plate comprising a pointed front corner.

In a further illustrative embodiment of the vertical mixer outlined above, the shallow angle β is less than 25°.

In a further illustrative embodiment of the vertical mixer outlined above, the shallow angle β is between about 5° and 20°.

In a further illustrative embodiment of the vertical mixer outlined above, the slide plate includes a concave portion.

In a further illustrative embodiment of the vertical mixer outlined above, the auger further comprises a spacer device on an underside of the bottom flight of the auger for contact with the floor of the mixing chamber.

In a further illustrative embodiment of the vertical mixer outlined above, the spacer device is selected from the group consisting of a bearing surface, a wear surface, and a block.

In a further illustrative embodiment of the vertical mixer outlined above, the flighting further comprises a second flight and the second flight has an increasing pitch relative the bottom flight.

In another illustrative embodiment there is provided a vertical mixer for mixing bulk material, the vertical mixer comprising:
a mixing chamber for receiving the bulk material, the mixing chamber being defined by a floor and a peripheral wall, the mixing chamber comprising a door for allowing exit of mixed bulk material; and
a vertical auger in the mixing chamber, the vertical auger having an auger post and flighting including a lower flight and an upper flight above the lower flight, the upper flight having an increased pitch relative the lower flight.

In another illustrative embodiment there is provided a vertical mixer for mixing bulk material, the vertical mixer comprising:
a mixing chamber for receiving the bulk material, the mixing chamber being defined by a floor and a peripheral wall, the mixing chamber comprising a door for allowing exit of mixed bulk material;
a vertical auger in the mixing chamber, the vertical auger having an auger post and flighting including a bottom flight; and
a spacer device on an underside of the bottom flight of the auger for contact with the floor of the mixing chamber.

In another illustrative embodiment there is provided a vertical mixer for mixing bulk material, the vertical mixer comprising:
a mixing chamber for receiving the bulk material, the mixing chamber being defined by a floor and a peripheral wall, the mixing chamber comprising a door for allowing exit of mixed bulk material;
a vertical auger in the mixing chamber, the vertical auger having an auger post and flighting including a bottom flight, the bottom flight having a front leading edge and an outside edge defining an outside footprint of the bottom flight;
a plurality of slide plates connected to the bottom flight for guiding bulk material at least inwards towards the auger post, each slide plate extending from the bottom flight at a different angle β from the floor, and wherein angle β is between about 1° and less than about 90°.

In one illustrative embodiment there is provided a vertical mixer for mixing bulk material, the vertical mixer comprising:
a mixing chamber for receiving the bulk material, the mixing chamber being defined by a floor and a peripheral wall, the mixing chamber comprising a door for allowing exit of mixed bulk material;
a vertical auger in the mixing chamber, the vertical auger having an auger post and flighting including a bottom flight; and
a spacer device directly or indirectly connected to the bottom flight of the auger, the spacer device comprising a component extending below the bottom flight of the auger for contact with the floor of the mixing chamber.

In a further illustrative embodiment of the vertical mixer outlined above, the spacer device is connected to an underside of the bottom flight of the auger.

In a further illustrative embodiment of the vertical mixer outlined above, the component is between an underside of the bottom flight of the auger and the floor of the mixer chamber.

In a further illustrative embodiment of the vertical mixer outlined above, the component is a bearing surface for contacting the floor of the mixing chamber.

In a further illustrative embodiment of the vertical mixer outlined above, the component is a bearing surface, block or wear surface.

In a further illustrative embodiment of the vertical mixer outlined above, the spacer device is located on the bottom ¼ of the bottom flight.

In one illustrative embodiment there is provided a vertical mixer comprising:
a mixing chamber for receiving the bulk material, the mixing chamber being defined by a floor and a peripheral wall, the mixing chamber comprising a door for allowing exit of mixed bulk material;
a vertical auger in the mixing chamber, the vertical auger having an auger post and flighting including a bottom flight; and
   a spacer device connected to the bottom flight of the auger, the spacer device comprising a component between an underside of the bottom flight of the auger and the floor of the mixer chamber for contacting the floor of the mixing chamber and providing support to at least a portion of the bottom flight of the auger.

### BRIEF DESCRIPTION OF THE DRAWINGS

FIG. 1 is an isometric view illustrating one example of a vertical mixer;

FIG. 2A is an overhead view illustrating one example of an auger for a vertical mixer;

FIGS. 2B and 2C are side views illustrating the auger of FIG. 2A;

FIG. 2D is an elevated perspective view of the auger of FIG. 2A;

FIG. 3 is an overhead view illustrating one example of a vertical mixer with an example of an auger; and

FIG. 4 is a side view illustrating one example of a space device connected to an auger.

### DETAILED DESCRIPTION

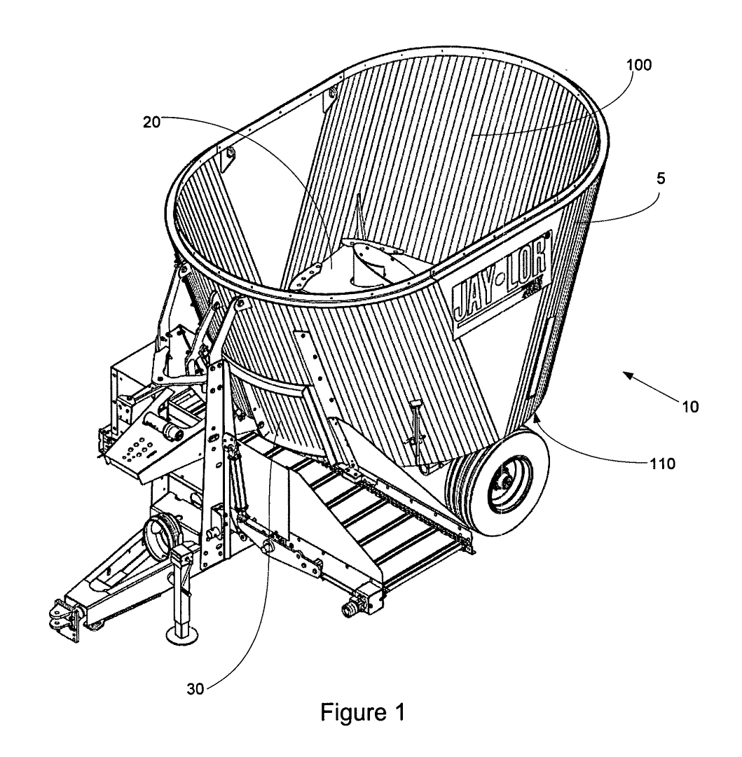

One embodiment of a vertical mixer having an improved auger is shown with reference to FIG. 1. A vertical mixer 10 has a mixing chamber 5 for receiving bulk material to be mixed. The mixing chamber 5 has an open top for receiving the bulk material, a floor 110, and depending walls 100 defining the mixing chamber 5. A vertical auger 20 is situated in the mixing chamber 5 in a conventional fashion. The mixing chamber 5 includes a door 30 through which mixed bulk material exits the mixing chamber 5 when the door 30 is opened.

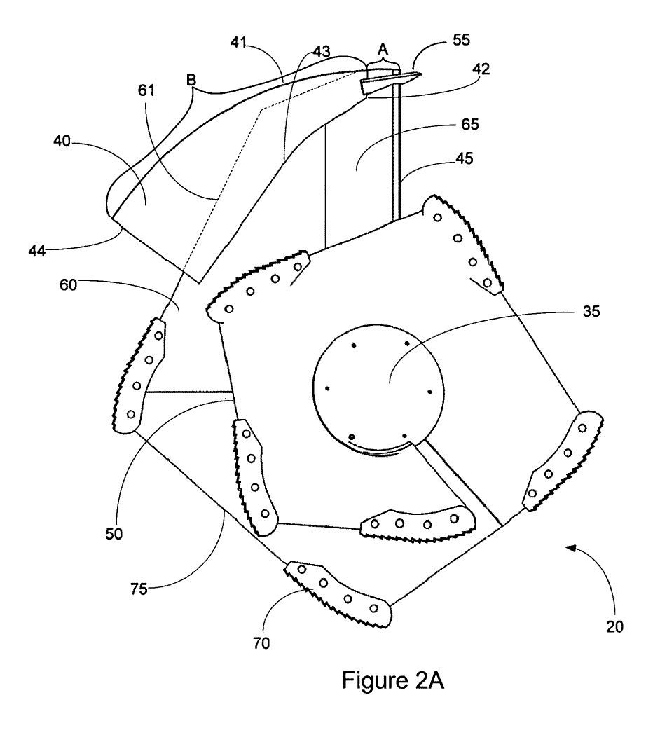

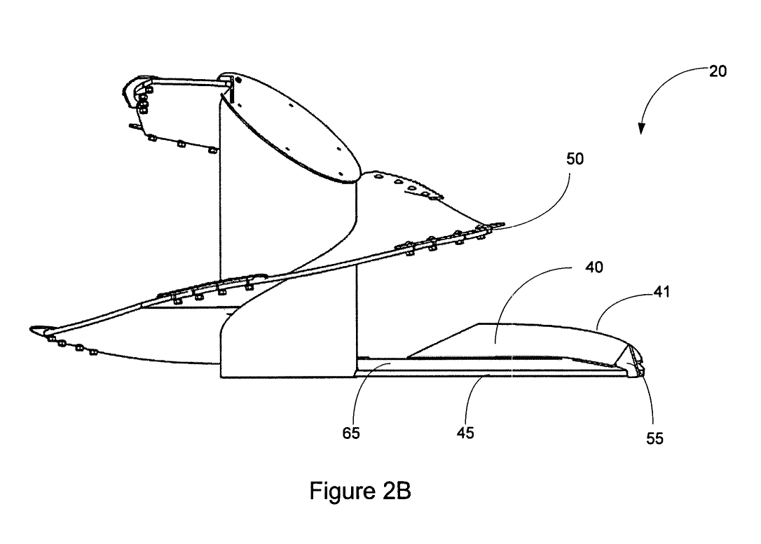

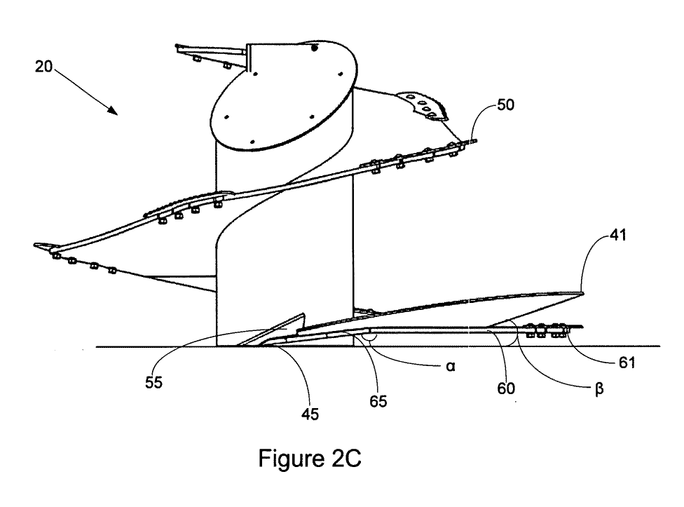

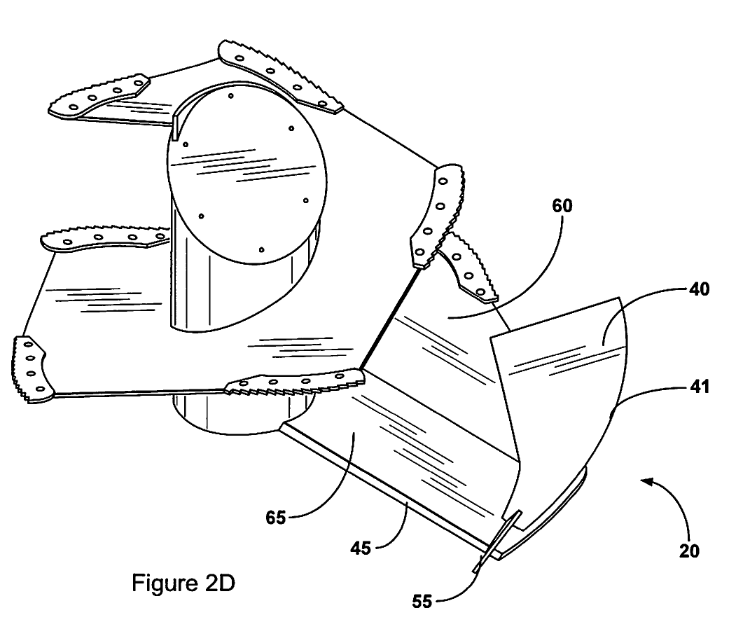

One embodiment of an example of an improved auger 20 is shown with reference to FIGS. 2A, 2B, 2C and 2D. The improved auger 20 guides bulk material from an outer region of the mixing chamber at least somewhat inwards towards a post 35 of the auger 20. An advantage of the improved auger 20 is that mix quality of the bulk material is improved. Material from an outer region of the mixing chamber is at least somewhat guided inwards towards the post 35 in a manner wherein damaging and compacting of the bulk material is reduced, relative to prior art vertical mixers, and the guided bulk material is further mixed. The improved mix quality is achieved, for example, using an improved auger such as that shown in FIGS. 2A-2D, and contains fewer clumps and is less densely packed than mixed bulk material of prior augers and vertical mixers. Further, it has been found that the time required to cut and mix a given amount of bulk material may be reduced using an auger disclosed herein and such as that shown in FIGS. 2A-2D relative to various prior art vertical mixers, such as for example, that shown in U.S. Pat. No. 5,863,122. In many cases, mix time is reduced to under 10 minutes. Additionally, the amount of power required to mix a given amount of bulk material has been shown to be reduced when using an improved auger such as that shown in FIGS. 2A-2D relative to various prior art vertical mixers such as, for example, that shown in U.S. Pat. No. 5,863,122. Shorter mixing times and less power lessen the amount of wear on the mixer and its components.

A further advantage provided by an auger 20 disclosed herein is a reduction in wasted bulk material due to loss of bulk material from the mixing chamber 5 through the open top. As an auger 20 disclosed herein is adapted to guide the bulk material in at least an outer region of the mixing chamber 5 at least somewhat inwards towards the post 35 of the auger 20 and less so upwards away from the floor 110 of the mixing chamber 5, less bulk material is thrown from the vertical mixer 10 through the open top of the mixing chamber 5.

The improved auger 20 shown in FIGS. 2A-2D comprises a plurality of knives 70 and flighting including at least a bottom flight 75 and a second flight 50. The second flight 50, for the purposes of this specification, is defined as the first flight above the bottom flight 75. It will be appreciated that the auger flighting may contain more than two flights and that the flighting may be tapered, expanding from the top flight to the bottom flight. Alternatively, the flighting may contain only a single flight, which for the purposes of the description, is referred to as the bottom flight. It will also be appreciated that the bottom flight, the second flight, and any other flights described herein are typically joined as part of a connected, continuous flighting, though they need not be.

The bottom flight 75 has an outside edge 61 defining the outside footprint of the bottom flight 75.

The bottom flight 75 terminates in a leading edge 45. The leading edge 45 is elevated slightly above the floor of the mixing chamber 5. The leading edge 45 may be shaped to be substantially parallel to the floor.

The bottom flight 75 may also include a fiat section 60. The flat section 60 is substantially parallel to the floor 110 of the mixing chamber 5 resulting in an increasing pitch between the second flight 50 and the bottom flight 75 over the span of the flat section 60. The flat section 60 may be elevated slightly from the floor of the mixing chamber 5 to minimize or prevent binding of bulk material between the floor 110 and the bottom flight 75 of the auger 20. The flat section 60 may be shaped to be elevated above the floor 110 of the mixing chamber 5 at a level higher than the leading edge 45. This may be accomplished by providing an angled section 65 connecting the leading edge 45 with the flat section 60. The angled section 65 may be at least 6 inches in length from the leading edge 45 to the flat section 60, and may be placed at a shallow angle α relative the flat section 60 such that the leading edge 45 is lower to the floor 110 than the flat section 60. The angled section 65 may be longer than 6 inches thereby being at a shallower angle relative the flat section 60. By having a longer angled section 65 of at least 6 inches at a shallower angle α (i.e., a larger angle α), compacting of the bulk material against the leading edge 45 and the angled section 65 is decreased. Alternatively, the angled section 65 may be at least 10.5 inches in length.

To help guide bulk material in an outer region of the mixing chamber 5, a slide plate 40 is used. The slide plate 40 is connected to the bottom flight 75 along a bottom edge 43. The slide plate 40 further includes a top edge 41 opposite the bottom edge 43 which may generally extend beyond the outside edge 61 towards the wall 100 of the mixing chamber 5. In one embodiment, the top edge 41 of the slide plate 40 extends outside of the footprint of the bottom flight 75 and may also be substantially proximate at least a portion of an interior side of the wall 100 of the mixing chamber 5 thereby guiding bulk material along the wall 100 of the mixing chamber 5 inwards toward the post 35. The slide plate 40 may terminate at the front end at a front corner 42 and at the back end at a back edge 44. To increase performance of the slide plate 40 at least a portion of the bottom edge 43 may be closer to the post 35 than the front corner 42. Such an arrangement facilitates sliding and/or guidance of bulk material at least in an inwards direction towards the post 35. The slide plate 40 extends up from the bottom flight 75 at a shallow angle β relative the mixing chamber floor 110 to reduce damaging of the bulk material while still imparting at least some inward guiding force for guiding bulk material towards the post 35. An angle β of up to 25° is preferred. An angle β of between about 5° and about 20° is more preferred. In one embodiment, the slide plate 40 extends on the bottom flight 75 across both of the angled section 65 and the flat section 60 and is connected at the front corner 42 of the slide plate 40 proximate the leading edge 45. The slide plate 40 may also optionally incorporate a concave bend. It will be appreciated that the front corner 42 may form part of a front edge which may be straight or curved. For the purposes of this specification, reference to the front corner 42 also encompasses the front edge which may be straight or curved.

The slide plate 40 may be attached with the front corner 42 proximate the front leading edge 45 or may be set back slightly away from the front leading edge 45. The distance A is the distance from which the front corner 42 is set back from the front leading edge 45 and the distance B is the length of the top edge 41 of the slide plate 40. In one embodiment the ratio of A:B is between about 0:100 and about 30:70. In another embodiment the ratio is up to 25:75 and in another embodiment the ratio is up to 20:80. It will be appreciated that positioning of the slide plate 40 relative the front leading edge 45 as well as the angle β may be selected as desired based for example on the type of bulk material to be mixed, the size of the mixing chamber, the size of the auger, the weight of the bulk material, the size of the driving motor of the auger 20, etc, without departing from the scope of the invention.

In another embodiment, the slide plate 40 may form part of the bottom flight 75 and may not be a separate connected piece. It is therefore within the scope of the auger 20 to have a slide plate 40 which is integrated into the bottom flight 75 through, for example, bending, cutting, shaping, etc.

The auger 20 may optionally include a spear plate 55. The spear plate 55 extends beyond the leading edge 45 and has a pointed front corner. The spear plate 55 is shaped and positioned to facilitate exit of the mixed and cut bulk material through the door 30 when in the opened position. Depending on the type of door used in the mixing chamber 5, exit of the mixed bulk material can be in lumps as bulk material can slide off of the outside edge of the auger 20 as the leading edge 45 passes the open door. To increase the evenness of the exit of mixed bulk material through the open door 30, the spear plate 55 may be used. However, the spear plate 55 is not essential to the functional operation of the auger 20 and vertical mixer 10. The spear plate 55 reduces the amount of feed that slides off of the outside edge of the auger 20 as the leading edge 45 passes the open door. Use of the spear plate 55 can reduce these lumps by reducing the amount of feed that slides off of the outside edge of the auger 20.

An auger such as those described above may be used with a vertical mixer, which includes a door having both or either of a wall and a floor component.

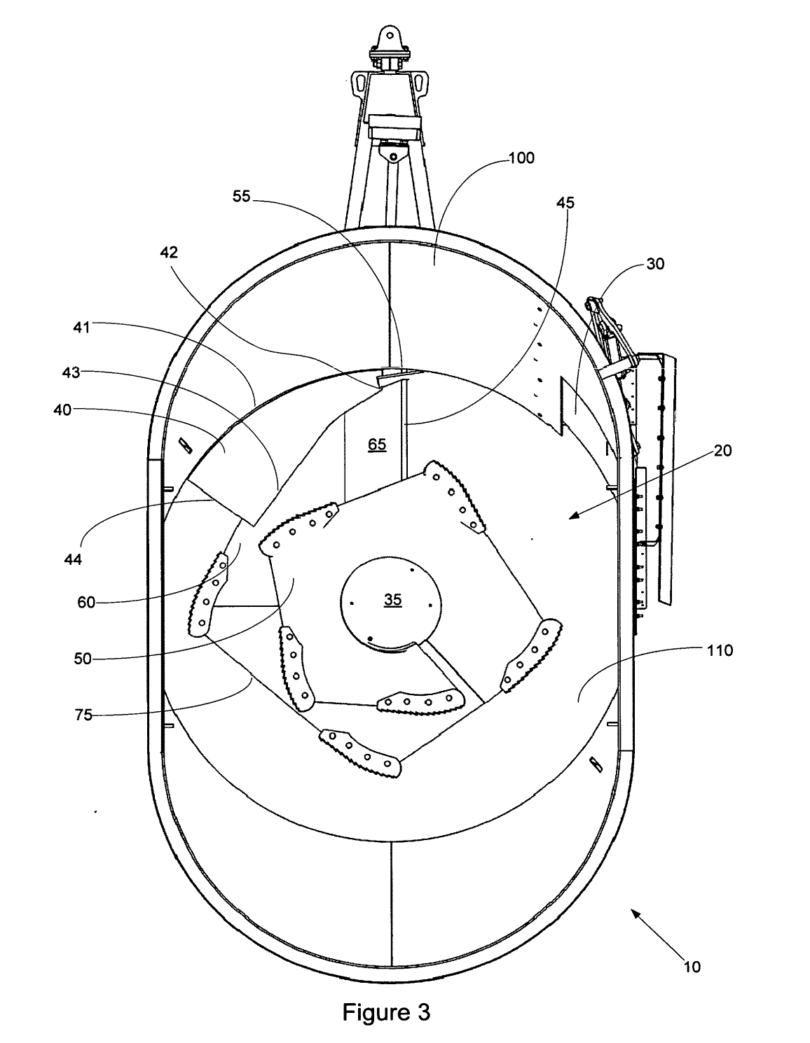

FIG. 3 is an overhead view of an example of a vertical mixer 10 with an auger 20 situated on a floor 110 of the mixing chamber 5. The auger 20 includes a slide plate 40 extending beyond the footprint of the bottom flight 75 of the auger 20. The top edge 41 of the slide plate 40 is adapted to be proximate a portion of an interior side of a wall 100 of the mixing chamber 5. Rotation of the auger 20 results in the leading edge 45 gently contacting the bulk material. The angled section 65 gently contacts the bulk material with reduced compacting forces, relative to prior art mixers, and the slide plate 40 guides the bulk material in the outer region of the mixing chamber 5 at least somewhat inwards towards the post 35 wherein the remaining flights of the auger 20 impart further mixing forces to the bulk material. The increasing pitch between the second flight 50 and the flat section 60 of the bottom flight 75 further reduces damaging and compacting of the bulk material during mixing. The bulk material which has been guided inwards is guided generally upwards as it approaches the post 35 where it is then positioned to be generally recycled down along an outer region of the mixing chamber 5.

Once it has been determined that the bulk material is sufficiently mixed, a door 30 is opened and the mixed bulk material exits from the mixing chamber 5 by movement of the rotating auger 20. Exit of the mixed bulk material is evened out through the optional use of a spear plate 55 extending forward from the leading edge 45 of the angled section 65.

The door 30 of the mixing chamber 5 may optionally include either or both of a floor component and a wall component.

Use of an auger 20 as described herein has shown to require less horsepower to mix bulk material and therefore it can be predicted that less fuel is required for operation of the auger mixing bulk material.

Bulk material mixed using an auger as described herein has been shown to be of a high quality having a density which is not overly compact and which, depending on the material, contains fibres of a desirable length for consumption by livestock. It has also been found that mixing of bulk material to a desired level of mix is achieved in a shorter amount of time relative to prior mixers. Less horsepower and less operating time results in reduced amount of wear on the mixer and its components.

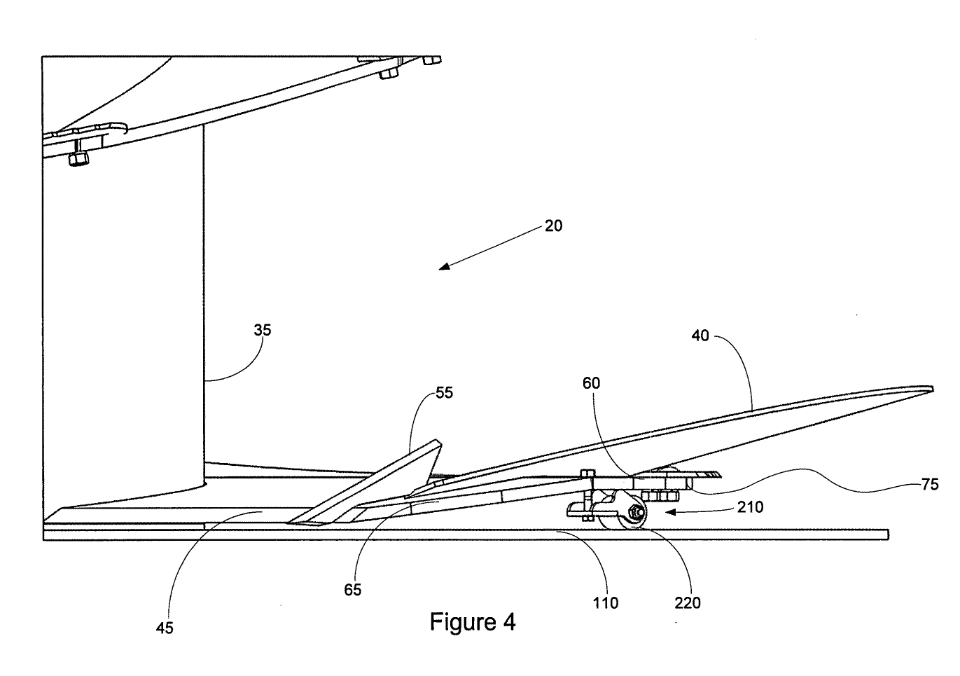

In an alternative embodiment, an auger 20, as shown in FIG. 4, may further include a spacer device 210 for placement on the bottom flight 75, with a component thereof between the underside of the bottom flight 75 and floor 110 of the mixing chamber. The spacer device 210, for example comprising a bearing surface 220, block or wear surface (not shown), allows for the bottom flight 75 of the auger to flex downwards towards the floor 110 when a mass is placed on top of the auger 20, such as bulk material, and acts as a spacer between the under side of the bottom flight 75, including the leading edge 45, an optional angled section 65 and/or an optional flat section 60, and the floor 110 of the mixing chamber. A bearing surface 220 may be used which reduces friction between the two surfaces and prevents both the underside of the bottom flight 75 and the floor 110 of the mixing chamber from excessive wear. Usually, because of the nature of construction of the auger 20 the outer region of the auger flighting tends to flex more than the inner region of the flighting and as such, the spacer device 210 may be positioned in an outer region of the bottom flight 75, including one or more of the optional flat section 60, the optional angled section 65 and the leading edge 45 of the bottom flight 75. The spacer device 210 may be located on a bottom ¼ of the bottom flight.

In another embodiment, an auger having flighting including a bottom flight may have a plurality of slide plates connected to the bottom flight and extending up therefrom for guiding bulk material at least somewhat inwards toward the auger post. In such an embodiment each of the slide plates extends up from the bottom flight at a different angle β relative the floor for guiding the bulk material at least somewhat inwards toward the auger post. The angle between each of the slide plates and the floor may be between about 1° and less than about 90° or between about 1° and less than about 85°. Additionally, one of the slide plates may be a spear plate, the spear plate being having a front corner extending beyond the front leading edge of the bottom flight, ending before the front leading edge of the bottom flight or ending flush with the front leading edge of the bottom flight. In such an embodiment, each of the plurality of slide plates may or may not extend beyond the outside footprint of the bottom flight of the auger.

The present invention has been described with regard to a plurality of illustrative embodiments. However, it will be apparent to persons skilled in the art that a number of variations and modifications can be made without departing from the scope of the invention as defined in the claims.

1. A vertical mixer for mixing bulk material, the vertical mixer comprising:
a mixing chamber for receiving the bulk material, the mixing chamber being defined by a floor and a peripheral wall, the mixing chamber comprising a door for allowing exit of mixed bulk material;
a vertical auger in the mixing chamber, the vertical auger having an auger post and flighting including a bottom flight, the bottom flight having a front leading edge and an outside edge defining an outside footprint of the bottom flight; and
a slide plate connected to the bottom flight for guiding bulk material at least inwards towards the auger post, the slide plate comprising:
a front corner;
a bottom edge; and
a top edge opposite the bottom edge;
the bottom edge having a portion closer to the auger post than the front corner; and
the slide plate extending from the bottom flight at a shallow angle b from the floor of the mixing chamber.

2. The vertical mixer of claim 1, wherein a distance between the front leading edge and the front corner A and a length of the top edge B has a ratio of between about 0:100 and about 30:70.

3. The vertical mixer of claim 1, wherein the slide plate further comprises a portion extending inward on the bottom flight away from the outside edge of the bottom flight.

4. The vertical mixer of claim 3, wherein the portion of the bottom edge closer to the auger post than the front corner and the portion of the bottom edge extending inward on the bottom flight away from the outside edge of the bottom flight overlap.

5. The vertical mixer of claim 1, wherein the top edge of the slide plate extends beyond the outside edge of the bottom flight.

6. The vertical mixer of claim 1, wherein the top edge of the slide pate extends beyond the outside edge of the bottom flight and is substantially proximate a portion of an interior side of the peripheral wall of the mixing chamber.

7. The vertical mixer of claim 1, wherein the bottom flight further comprises a flat section substantially parallel with the floor of the mixing chamber, and a second flight of the auger has an increasing pitch relative the bottom flight.

8. The vertical mixer of claim 7, wherein the bottom flight further comprises an angled section between the leading edge and the flat section such that the leading edge is closer to the floor than the flat section.

9. The vertical mixer of claim 8, wherein the angled section is at least 6 inches in length.

10. The vertical mixer of claim 1, wherein the front corner of the slide plate is connected proximate the front leading edge of the bottom flight.

11. The vertical mixer of claim 7, wherein the front corner of the slide plate is connected proximate the front leading edge of the bottom flight and the slide plate is connected to at least a portion of the flat section.

12. The vertical mixer of claim 1, wherein the slide plate includes a concave portion.

13. The vertical mixer of claim 1, wherein the shallow angle β is less than 25°.

14. The vertical mixer of claim 1, wherein the shallow angle β is between about 5° and 20°.

15. The vertical mixer of claim 1, further comprising a spear plate extending forward beyond the front leading edge, the spear plate comprising a pointed front corner.

16. The vertical mixer of claim 1, further comprising a spacer device connected to the bottom flight comprising a part thereof for contact with the floor of the mixing chamber.

17. The vertical mixer of claim 16, wherein the spacer device is selected from the group consisting of a bearing surface, a wear surface, and a block.

18. A vertical mixer for mixing bulk material, the vertical mixer comprising:
a mixing chamber for receiving the bulk material, the mixing chamber being defined by a floor and a peripheral wall, the mixing chamber comprising a door for allowing exit of mixed bulk material;
a vertical auger in the mixing chamber, the vertical auger having an auger post and flighting including a bottom flight, the bottom flight comprising:
a front leading edge;
an outside edge defining an outside footprint of the bottom flight;
a flat section substantially parallel with the floor of the mixing chamber; and
an angled section connecting the front leading edge and the flat section such that the leading edge is closer to the floor than the flat section, the angled section having a length of at least 6 inches.

19. A vertical mixer for mixing bulk material, the vertical mixer comprising:
a mixing chamber for receiving the bulk material, the mixing chamber being defined by a floor and a peripheral wall, the mixing chamber comprising a door for allowing exit of mixed bulk material;
a vertical auger in the mixing chamber, the vertical auger having an auger post and flighting including a bottom flight; and
a spacer device on an underside of the bottom flight of the auger for contact with the floor of the mixing chamber.

20. A vertical mixer for mixing bulk material, the vertical mixer comprising:
a mixing chamber for receiving the bulk material, the mixing chamber being defined by a floor and a peripheral wall, the mixing chamber comprising a door for allowing exit of mixed bulk material;
a vertical auger in the mixing chamber, the vertical auger having an auger post and flighting including a bottom flight; and
a spacer device directly or indirectly connected to the bottom flight of the auger, the spacer device comprising a component extending below the bottom flight of the auger for contact with the floor of the mixing chamber.

21. The vertical mixer of claim 20, wherein the spacer device is connected to an underside of the bottom flight of the auger.

22. The vertical mixer of claim 20, wherein the component is between an underside of the bottom flight of the auger and the floor of the mixer chamber.

23. The vertical mixer of claim 20, wherein the component is a bearing surface for contacting the floor of the mixing chamber.

24. The vertical mixer of claim 20, wherein the component is a bearing surface, block or wear surface.

25. The vertical mixer of claim 20, wherein the spacer device is located on the bottom ¼ of the bottom flight.

26. A vertical mixer for mixing bulk material, the vertical mixer comprising:
a mixing chamber for receiving the bulk material, the mixing chamber being defined by a floor and a peripheral wall, the mixing chamber comprising a door for allowing exit of mixed bulk material;
a vertical auger in the mixing chamber, the vertical auger having an auger post and flighting including a bottom flight; and
a spacer device connected to the bottom flight of the auger, the spacer device comprising a component between an underside of the bottom flight of the auger and the floor of the mixer chamber for contacting the floor of the mixing chamber and providing support to at least a portion of the bottom flight of the auger.

27. The vertical mixer of claim 26, wherein the component is a bearing surface for contacting the floor of the mixing chamber.

28. The vertical mixer of claim 20, wherein the component is a bearing surface, block or wear surface.
